(19) United States
(12) Patent Application Publication
(10) Pub. No.: US 2025/0036944 A1
(43) Pub. Date: Jan. 30, 2025

(54) METHOD AND A SYSTEM FOR THE OPTIMIZED TRAINING OF A MACHINE LEARNING ALGORITHM

(71) Applicant: Robert Bosch GmbH, Stuttgart (DE)

(72) Inventors: Christian Heinzemann, Vellmar (DE); Christoph Gladisch, Renningen (DE); Martin Herrmann, Korntal (DE); Matthias Woehrle, Bietigheim-Bissingen (DE)

(21) Appl. No.: 18/775,238

(22) Filed: Jul. 17, 2024

(30) Foreign Application Priority Data
Jul. 27, 2023 (DE) 102023207211.4

(51) Int. Cl. G06N 3/08

(52) U.S. Cl. CPC G06N 3/08

(57) ABSTRACT

A method for optimized training of a machine learning algorithm. The method includes: providing a domain model that has domain parameters and/or domain values for at least one domain;
providing a data model that has a training data set including training data for the at least one domain;
removing/hiding/modifying at least one training datum from the training data set depending on at least one domain parameter and/or domain value to provide a reduced training data set;
training a neural network based on the reduced training data set to determine a model performance depending on the reduced data set; comparing the determined model performance with a model performance associated with the training data set; selecting training data from the training data set depending on the comparison of the model performances; training the machine learning algorithm based on the selected training data; and providing the trained machine learning algorithm.

### FIELD

The present invention relates to a method and a system for the optimized training of a machine learning algorithm. The present invention also relates to a computer program including program code, and a computer-readable data carrier including program code of a computer program.

### BACKGROUND INFORMATION

A domain model in the form of an ontology is a structured and semantic representation of a specific area of knowledge. In the field of machine learning models, the development of such domain models plays a crucial role in improving the understanding and interpretation of models. It also enables effective communication between experts, developers and users.

Building a domain model in the form of an ontology for machine learning models is generally an iterative process that requires the systematic collection and categorization of relevant knowledge. First, the various concepts and entities that are relevant in the domain are identified, such as data sources, models, algorithms, metrics, and evaluation methods. On the basis thereof, the relationships between the concepts are defined in order to capture their dependencies and connections. Classifications, aggregations, associations and hierarchies can be used to design the structure of the ontology. The definition of attributes and properties of the concepts enables a detailed description and characterization of the individual elements. These attributes may, for example, contain information about parameters, properties or fields of application of machine learning models.

In order to validate and improve the ontology, it is preferable to involve experts and practitioners. Their expertise and experience help to ensure the completeness and correctness of the model. The use of existing ontologies and standards may also be helpful to ensure consistency and interoperability.

A well-developed domain model in the form of an ontology enables a structured and uniform representation of knowledge in the field of machine learning models. It supports the understanding, interpretation and reusability of models and promotes efficient collaboration between experts, developers and users.

In the paper “Using ontologies for dataset engineering in automotive AI applications” (dx.doi.org/10.23919/DATE54114.2022.9774675), a method for building a domain model in the form of an ontology was described. The domain model describes effects and/or properties from the field of application or the domain of the machine learning model (so-called “dimensions” or domain parameters) and the possible forms in which these can occur (so-called “options” or domain values).

The paper “Datamodels: Predicting Predictions from Training Data” (arxiv.org/abs/2202.00622) describes the use of data models, i.e., the use of a machine learning model, in order to consider the influence of data points (and, by extension, classes) on the performance of a trained machine learning model.

Furthermore, a method for using combinatorial testing is described in the related art, which was developed for testing software. This describes an approach for incrementally building a data set with the aid of a domain model. This ensures that the dimensions and options of the domain model are covered, but the performance or efficiency of a trained machine learning model is not considered.

To date, the performance of a trained machine learning model has been insufficiently considered. The importance of the dimensions and options considered is also not addressed.

An object of the present invention is to provide a method for training a machine learning algorithm, by means of which, in particular, the performance of the machine learning algorithm or the machine learning model is improved with regard to the dimensions and options of the domain model. It is also an object of the present application to consider the importance of the dimensions and options of the domain model under consideration.

The object may be achieved by a method for the optimized training of a machine learning algorithm according to certain features of the present invention. Furthermore, the object may be achieved by a system for the optimized training of a machine learning algorithm according to certain features of the present invention.

### SUMMARY

In the present application, a method for the optimized training of a machine learning algorithm is disclosed. According to an example embodiment of the present invention, the method comprises at least the following steps:
providing a domain model that has domain parameters and/or domain values for at least one domain;
providing a data model that has a training data set comprising training data for the at least one domain;
removing and/or hiding and/or modifying at least one training datum from the training data set depending on at least one domain parameter and/or domain value in order to provide a reduced training data set, in particular in order to evaluate a sensitivity of the at least one removed and/or hidden domain parameter and/or domain value;
training a neural network on the basis of the reduced training data set in order to determine a model performance depending on the reduced data set;
comparing the determined model performance with a model performance associated with the training data set;

at least temporarily selecting training data from the training data set depending on the comparison of the model performances;
training the machine learning algorithm on the basis of the selected training data; and
providing the trained machine learning algorithm.

According to an example embodiment of the present invention, the data model preferably comprises image data and/or video data, which preferably represent different combinations of domain parameters and/or domain values for at least one domain. In principle, not all combinations of domain parameters and/or domain values need to be represented by the data model. An absence can be identified by the method according to the present invention if, for example, at least one domain parameter and/or domain value is at least temporarily hidden and/or removed, and no image data and/or video data for it are available.

The model performance associated with the training data set preferably describes a model performance that was ascertained on the basis of the entire training data set. The domain model does not necessarily have to have been included in this ascertainment.

According to an example embodiment of the present invention, a data model is linked to a domain model in order to thus be able to deduce which domain parameters and values are significant and therefore required in the training phase of the machine learning algorithm. Furthermore, this makes it possible to deduce what degree of interaction between the domain parameters and values must be used, in particular also depending on the domain parameters and/or values. The resulting data model is used to derive a (training) data set in order to train the machine learning algorithm or the machine learning model. The model trained in this way is then preferably robust against the diversity of the data model. It is always preferable, in particular due to computing power, to keep the training data set as small as possible. For example, there should be little redundancy. There are also economic reasons for keeping the training data set small, in particular in the case of (partially) supervised training methods, since the larger the training data set, the greater the labeling effort, which is often performed manually. However, the training data set should preferably not be too small in order to include sufficient variability across domain properties.

In the field of computer vision, a “domain model” preferably refers to a structured and/or semantic representation of an area of knowledge that is relevant for processing and/or analyzing visual information. It is used to improve the understanding of images, videos or other visual data through the use of computer vision techniques. A domain model may comprise various aspects, such as object recognition, facial recognition, image segmentation, motion analysis, image classification, and much more. It preferably comprises a collection of concepts, entities and/or relationships that represent the visual properties, features and/or structures that are relevant in the corresponding domain. Such a model may, for example, define classes of objects, such as cars, people or animals, and/or their characteristics and/or relationships to one another. It may also comprise algorithms and techniques used to process and analyze visual data, such as convolutional neural networks (CNNs), feature extraction or clustering methods. The development of a domain model preferably takes place by including expert knowledge in the fields of image processing, pattern recognition and/or artificial intelligence. An expert preferably identifies the relevant concepts and defines their relationships in order to achieve a comprehensive understanding of the domain. The domain model preferably supports the development of powerful computer vision applications, such as object recognition systems, autonomous vehicles, medical imaging, and/or video surveillance systems. It can also be helpful for integrating computer vision techniques into other application domains such as robotics, security and/or augmented reality.

The domain model preferably describes effects and/or properties from the field of application or the domain of the machine learning model. These effects and/or properties are also referred to as “dimensions” and are specified, for example, as domain parameters. One possible form of the effects and/or properties in which these may occur is preferably referred to as “options” and specified, for example, as domain values.

The present method according to the present invention can achieve that sufficient data are available in the training data set, during the training phase and/or during the ascertainment, whether for the individual dimensions and options of the domain model, as well as for their interactions. The present invention eliminates the need for dense sampling of the domain, which is still necessary for sensitivity analysis in some conventional machine learning algorithms, as well as the need to generate simulated or synthetic (training) data for the iterative improvement of the (training) data set.

By means of the present invention, it is possible to make a “discrete” statement as to whether further data can potentially increase model performance with respect to a particular effect. In addition, it is possible to capture the influence of interactions between different effects and to also evaluate how these affect the model performance. The present method increases the efficiency and quality of the training. Overall, this makes the training phase of the machine learning algorithm more cost-effective. In the present application, specific data models are deliberately utilized in order to avoid the need for full combinatorics and/or complete sampling of a dimension in the training data. Instead, a well-founded estimate can already be obtained with a subset or a partial set of data. Overall, in the present application, the training effort is thus significantly reduced.

In principle, the method according to the present invention can be used in all image-processing-based applications, in particular where annotated or labeled image data for a target domain are not or are only insufficiently available. The present method can in principle be used to analyze and/or process sensor data. This is particularly the case for driver assistance systems and/or fully automated driving and/or surveillance cameras and/or automation systems and/or other image processing fields, in particular where a large amount of data is preferred for training and/or applying assistance functions. Furthermore, the present invention also extends to an application for multimodal systems that are based, for example, on image data generated by a camera, a lidar sensor and/or a radar sensor or any combination thereof. The data used by the machine learning algorithm can come from at least one sensor. The sensor can ascertain measured values of the environment in the form of sensor signals, which may, for example, originate from the following sources: digital images, e.g. video, radar, LiDAR, ultrasound, motion, thermal images and/or audio signals. On the basis of the sensor signal, information about elements encoded by the sensor signal can be obtained (i.e., an indirect measurement can be performed based on the sensor signal used as a direct measurement).

The method for training a machine learning algorithm according to the present invention is particularly used in the areas of active learning and/or testing and/or evaluation or data curation. In particular, the present method can be used for the active selection of (training) data that a technical system, preferably any technical system, in particular an autonomous vehicle and/or a robotic system and/or an industrial machine, transmits to a back-end computer. As a result, data traffic can be reduced. Any bandwidth that is freed up can be used in particular to efficiently and effectively use the information for training a machine learning system.

On the basis of an improved domain model, according to the present invention, training data sets and/or test data sets of a machine learning algorithm can be curated better and/or more effectively. Splits can also be defined. By means of the present invention, it is also possible to select untagged or unlabeled data for tagging or labeling in order to use them, for example, for supervised learning or training of the machine learning algorithm. Furthermore, it is possible to implement and/or execute the present domain model in an in particular autonomously driving vehicle and/or a robotic system and/or an industrial machine, in order to effectively record (training) data on the basis of at least one trigger provided by the present domain model. From a technical point of view, the present method for training a machine learning algorithm is in particular aimed at the technical implementation of a mathematical method in order to execute it as computationally efficiently and effectively as possible on a computer and/or a control unit. In particular, in the present application, the internal technical functionalities of a computer and/or a processor have played a role in the design of the implementation of the method, in order to optimize the internal functionality of the computer and/or control unit. Such an optimization is achieved in particular by using the present data model to computationally avoid a combinatorial “explosion” associated with combinatorial tests.

The present training model achieves at least the following technical effects, which are particularly important when deriving (training) data sets from a domain model. On the one hand, sensitivity analysis is made possible, through which it is possible to ascertain which “dimensions” and/or “options” in the dimensions are crucial for a good or effectively usable training data set. It is also possible to ascertain how much interaction is required between different dimensions, which allows the necessary combinatorial interaction to be specified. In addition, the results of the method can support a selection of previously unlabeled or unmarked (training) data for which labeling is “worthwhile,” in particular on the basis of the sensitivity analysis and/or the performance analysis. This may be advantageous if, for example, the performance or efficiency of the trained machine learning algorithm or machine learning model is not yet saturated with respect to the effects comprised in the (training) data. In summary, described in the present application is thus a training method for selecting the most important effects or dimensions and/or their interaction or options from a description of a domain such that the performance of a machine learning model can be optimized, in particular with respect to a selectable metric. By using a data model, it can be ascertained which effects in the (training) data are important and/or which of these effects, and in particular to what extent these effects, should be taken into account in the (training) data sets.

It is understood that the steps according to the present invention as well as other optional steps do not necessarily have to be carried out in the order shown, but can also be carried out in a different order. Other intermediate steps can also be provided. The individual steps can also comprise one or more sub-steps without departing from the scope of the method according to the present invention.

In a preferred embodiment of the present invention, the training data for the at least one domain are marked in each case depending on at least one combination of domain parameters and/or domain values. The individual training data thus preferably have a label that corresponds to at least one particular combination of domain values with the associated domain parameters.

In a preferred embodiment of the present invention, the training data set of the data model has at least one prediction domain marker. The prediction domain marker preferably corresponds to a “standard label” from the related art, which gives the machine learning algorithm to be trained information as to which domain comprises the training data. After the algorithm has evaluated and/or classified and/or segmented an image datum and/or a video datum, this result is compared with the prediction domain marker, in order to check whether the algorithm has correctly captured the meaning comprised in the relevant image datum and/or video datum.

In a preferred embodiment of the present invention, the removal and/or hiding and/or modification of at least one training datum from the training data set depending on at least one domain parameter and/or domain value takes place successively and/or iteratively by varying the at least one domain parameter and/or domain value. The method comprises varying the at least one domain parameter and/or domain value in order to perform the removal, hiding or modification of the training datum. The exact nature of the variation and/or step-by-step procedure is not specified and can be implemented in various forms.

In a preferred embodiment of the present invention, the training of a particular neural network, the determination of the particular model performance and the comparison of the model performances take place for each training data set reduced in this way successively and/or iteratively, in order to thus select a subset from the training data set, on the basis of which subset the machine learning algorithm is trained. A neural network is trained for each removed and/or hidden and/or modified domain parameter and/or domain value in order to thus be able to determine the model performance and compare it with a reference model performance. The individual neural networks do not yet correspond to the machine learning algorithm to be trained, which is only trained once a training data set has been selected in this way and/or has been reduced starting from an original, larger training data set.

In a preferred embodiment of the present invention, the subset from the training data set comprises training data which have a predetermined influence, in particular depending on at least one threshold value, on the model performance. On the other hand, training data from the training data set that did not show any influence on the model performance in the present model performance comparison are preferably hidden, since these training data only require computing power during training, without having a positive effect on the quality and/or efficiency of the training.

In a preferred embodiment of the present invention, an interaction between at least two of the domain parameters and/or domain values can be ascertained on the basis of the comparison of the determined model performance with the model performance associated with the training data set. On the basis of the data model, embeddings in the data model can be calculated, preferably for specific instances. In the case of a linear data model, this is the embedding in a transformed space which is described by the coefficients of the data model. Embeddings preferably allow similarities and/or interactions between the training data to be identified. It can be ascertained which combinatorics of domain parameters and/or domain values should preferably be considered together in order to achieve a predetermined model performance.

In a preferred embodiment of the present invention, the machine learning algorithm comprises a neural network, in particular a deep neural network. A deep neural network is preferably a type of artificial neural network architecture that consists of a plurality of layers of neurons. Each layer processes the input data and passes them on to the next layer, allowing complex patterns and relationships to be learned. Deep neural networks are preferably used for tasks such as image and speech recognition, machine translation and other complex data processing tasks. The machine learning algorithm in the preferred embodiment preferably uses such a deep neural network.

In a preferred embodiment of the present invention, a production line comprising the equipment combination for producing specifiable products is furthermore provided. A production line is preferably a sequence of production stations and/or work areas arranged so that they work together to produce at least one product. This production line may comprise various devices, machines and/or systems that are configured to produce the specified products. In this embodiment, it is emphasized that, in the preferred embodiment, a specific equipment combination is present in the production line. This equipment combination could comprise, for example, machines, robots, automated assembly lines, tools and/or other devices necessary for the production of the specified products.

In a preferred embodiment of the present invention, after the production line has been provided, the method furthermore comprises the step of: producing at least one specifiable product using the equipment combination. According to this embodiment, after the production line has been provided, a method is carried out which aims to produce at least one specifiable product. This step takes place using the existing equipment combination in the production line. In the present application, the type of product or the exact sequence of the production process are not specified in detail. The focus is on the fact that, in the preferred embodiment, the method aims to produce at least one specifiable product by means of the provided equipment combination in the production line.

According to the present invention, a control unit is also provided, which is comprised in an autonomous vehicle and/or a robotic system and/or an industrial machine, and on which a machine learning algorithm trained according to the present method in one of its embodiments can be executed.

According to the present invention, a system for optimized training of a machine learning algorithm is also provided. According to an example embodiment of the present invention, the system comprises a provisioning device that is designed to provide a domain model that has domain parameters and/or domain values for at least one domain; and a data model that has a training data set comprising training data for the at least one domain. Furthermore, the system comprises an evaluation and computing device that is designed to remove and/or hide and/or modify at least one training datum from the training data set depending on at least one domain parameter and/or domain value in order to provide a reduced training data set; to train a neural network on the basis of the reduced training data set in order to determine a model performance depending on the reduced data set; to compare the determined model performance with a model performance associated with the training data set; to select training data from the training data set depending on the comparison of the model performances; and to train the machine learning algorithm on the basis of the selected training data; wherein the provisioning device is furthermore designed to provide the trained machine learning algorithm.

According to the present invention, a computer program having program code is also provided to carry out at least parts of the method according to the present invention in any of its embodiments when the computer program is executed on a computer. In other words, according to the present invention, a computer program (product) is provided comprising commands that, when the program is executed by a computer, cause the computer to carry out the method/steps of the method according to the present invention in any of its embodiments.

According to the present invention, a computer-readable data carrier having program code of a computer program is proposed to carry out at least parts of the method according to the present invention in any of its embodiments when the computer program is executed on a computer. In other words, the present invention relates to a computer-readable (memory) medium comprising commands that, when executed by a computer, cause the computer to perform the method/steps of the method according to the present invention in one of its embodiments.

The described embodiments and developments of the present invention can be combined with one another as desired.

Further possible embodiments, developments and implementations of the present invention also include combinations not explicitly mentioned of features of the present invention described above or in the following relating to the exemplary embodiments of the present invention.

### BRIEF DESCRIPTION OF THE DRAWINGS

The figures are intended to impart further understanding of the example embodiments of the present invention. They illustrate example embodiments and, in the context of the description, serve to explain principles and concepts of the present invention.

Other embodiments and many of the mentioned advantages are apparent from the figures. The illustrated elements of the figures are not necessarily shown to scale relative to one another.

FIG. 1 shows a schematic flow chart of an exemplary embodiment of the present method for the optimized training of a machine learning algorithm.

FIGS. 2A and 2B show a schematic block diagram of a comparison between a conventional training method (FIG. 2A) and the present method (FIG. 2B) for the optimized training of a machine learning algorithm.

In the figures, identical reference signs denote identical or functionally identical elements, parts or components, unless stated otherwise.

### DETAILED DESCRIPTION OF EXAMPLE EMBODIMENTS

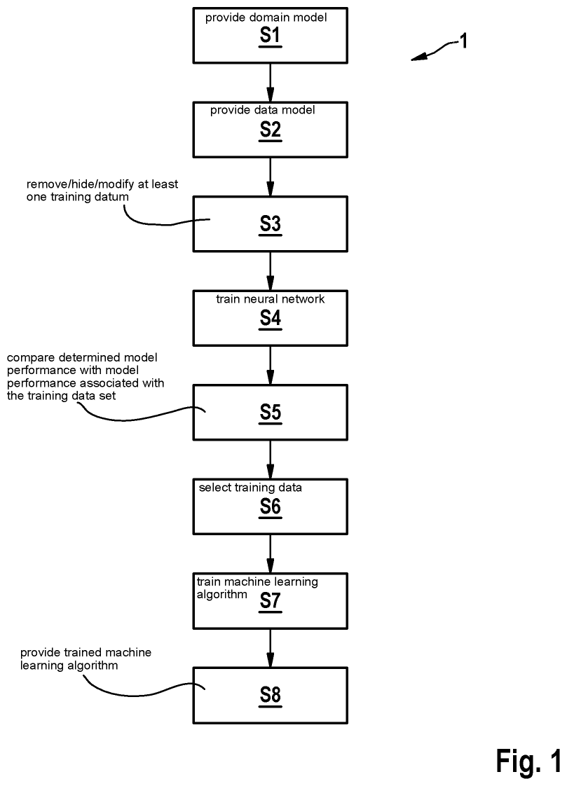

FIG. 1 shows a schematic flow chart of a method for the optimized training of a machine learning algorithm.

In any embodiment, the method can be carried out at least in part by a system 1, which for this purpose can comprise a plurality of components not shown in more detail, for example one or more provisioning devices and/or at least one evaluation and computing device. It is self-evident that the provisioning device can be designed together with the evaluation and computing device, or can be different therefrom. Furthermore, the system can comprise a storage device and/or an output device and/or a display device and/or an input device.

In the present application, the computer-implemented method for the optimized training of a machine learning algorithm comprises at least the following steps:

In a step S1, a domain model that has domain parameters and/or domain values for at least one domain is provided.

In a step S2, a data model that has a training data set comprising training data for the at least one domain is provided.

In a step S3, at least one training datum from the training data set is removed and/or hidden and/or modified depending on at least one domain parameter and/or domain value in order to provide a reduced training data set.

In a step S4, a neural network is trained on the basis of the reduced training data set in order to determine a model performance depending on the reduced data set.

In a step S5, the determined model performance is compared with a model performance associated with the training data set.

In a step S6, training data are selected from the training data set depending on the comparison of the model performances.

In a step S7, the machine learning algorithm is trained on the basis of the selected training data.

In a step S8, the trained machine learning algorithm is provided.

The removal and/or hiding and/or modification S3 of at least one training datum from the training data set depending on at least one domain parameter and/or domain value particularly preferably takes place successively and/or iteratively by varying the at least one domain parameter and/or domain value. The training of a particular neural network, the determination of the particular model performance and the comparison of the model performances particularly preferably take place for each training data set reduced in this way successively and/or iteratively, in order to thus select a subset from the training data set, on the basis of which subset the machine learning algorithm is trained.

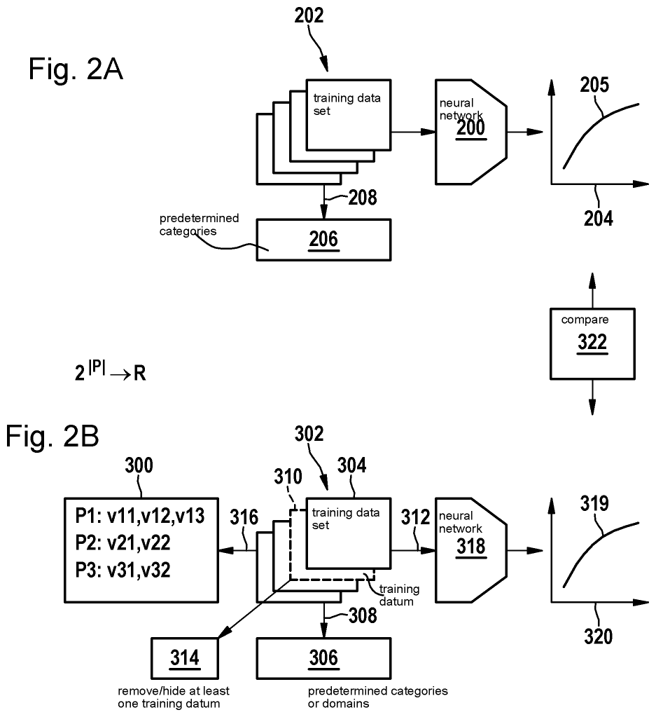

FIGS. 2A and 2B show a comparison between a conventional training method (FIG. 2A) and the present method for optimized training (FIG. 2B).

According to FIG. 2A, a neural network 200 is trained by means of a training data set 202 of training data. The model trained in this way has a particular model performance 205, which is shown schematically in a graph 204. Optionally, the training data of the training data set 202 may be marked or labeled depending on predetermined categories 206, for example prediction classes. The labeling is indicated by reference sign 208.

FIG. 2B shows an exemplary embodiment of the method according to the present invention for the optimized training of a machine learning algorithm. A domain model 300 is provided, which can be defined, for example, by a plurality of domain parameters P1, P2, P3, in each case with associated domain values v11, v12, v13; v21, v22; and v31, v32, v33. Furthermore, a data model 302 is provided, which has a training data set 304 comprising training data for the at least one domain. Optionally, the training data of the training data set 304 may be marked or labeled depending on predetermined categories or domains 306, for example prediction classes. The labeling is indicated by reference sign 308. In the present application, at least one training datum 310 from the training data set 304 is, by way of example, at least temporarily removed and/or hidden depending on at least one domain parameter P3 and/or domain value v33 in order to provide a reduced training data set 312. The removal and/or hiding is indicated by reference sign 314. This makes it possible to determine an influence on the model performance depending on an in particular isolated domain parameter and/or domain value. In the present application, the individual training data of the training data set 304 are labeled depending on the domain parameters P1, P2, P3 and the respectively associated domain values v11, v12, v13; v21, v22; and v31, v32, v33. Thus, for example, each training datum of the training data set 304 is associated with at least one marker for a particular configuration of domain parameters and domain values. This marker is indicated by reference sign 316. In the present application, for example, at least one training datum that has the domain value v33 for the domain parameter or is marked as such was removed. Consequently, a neural network 318 is in each case trained on the basis of the reduced training data set 312 in order to determine a model performance depending on the reduced data set 312. The determined model performance 319 for the neural network 318 trained with the reduced data set 312 is schematically indicated in a graph 320. The model performance 319 thus determined or specified by the neural network 318 trained on the basis of the reduced data set 312 is compared with the model performance 205 associated with the (entire) training data set. The comparison is indicated by reference sign 322 and corresponds to step S5.

In the present application, on the basis of the comparison, training data can be selected from the training data set, which is no longer shown in FIG. 2B. The data model 302 enriched by the preferably semantic domain model makes it possible to determine a partial set or a subset of training data and/or combinatorial cases of domain parameters and domain values and to preferably ascertain therefrom a global performance behavior, in particular by successive and/or partial removal and/or addition of data points X′ \in X with specific domain values from the domain model.

The machine learning algorithm can then be trained on the basis of the selected training data.

In the present application, a, preferably semantic, domain model is thus in particular enriched with a learned data model. The domain model S preferably comprises a plurality of input variables D_{N} and can be expressed as follows.

S={D₁, . . . , D_{N}}, where each Dᵢ={Dᵢ₁, . . . , Dᵢₖ}

X, Y, M can be defined as (training) data, where x \in X is an input datum, y \in Y is an optional label for a prediction, and m \in M is a description of x in the domain model S.

The data model can be defined as follows: f(x)→y′

With the cost function: L(y′), if applicable L(y, y′)

In the present application, a data model D_{M}=g(s)=g(D₁₁, . . . D_{NK})→R is particularly preferably calculated and/or specified.

For a comprehensive combinatorics of the domain model, a prediction of the resulting model performance of a neural network is preferably formed. The data model is preferably calculated according to methods known in principle, although the data model is calculated for a specific instance s \in S in contrast to the related art. In other words, mapping to a domain model takes place for the calculation of the data model.

As model output S′ with |S'|<|S|, a subset of training data that can be effectively used for training the machine learning algorithm can particularly preferably be ascertained and/or output. The subset of training data preferably represents the scenarios for the domain parameters and/or domain values that have a significant influence on the model performance. Furthermore, in the present application it is possible to output an estimate of a degree of interaction k, in particular for combinatorial testing. For example, an investigation with regard to (un)important combinations of domain parameters and/or domain values can take place. Using the data model reduced in this way and/or the determined degree of interaction, (training) data X′ that satisfy a predetermined quality level of the domain model are preferably selected from X. If not available, labels for supervised learning can optionally be created for this reduced (training) data set. The resulting (training) data set is then used to train the machine learning algorithm, which is robust against the data model.

14. (canceled)

15. A method for optimized training of a machine learning algorithm, the method comprising the following steps:
providing a domain model that has domain parameters and/or domain values for at least one domain;
providing a data model that has a training data set including training data for the at least one domain;
removing and/or hiding and/or modifying at least one training datum from the training data set depending on: (i) at least one domain parameter and/or (ii) at least one domain value, to provide a reduced training data set to evaluate a sensitivity of the at least one removed and/or hidden training datum;
training a neural network based on the reduced training data set to determine a model performance depending on the reduced data set;
comparing the determined model performance with a model performance associated with the training data set;
selecting training data from the training data set depending on the comparison of the model performances;
training the machine learning algorithm based on the selected training data; and
providing the trained machine learning algorithm.

16. The method according to claim 15, wherein the training data for the at least one domain are marked in each case depending on at least one combination of domain parameters and/or domain values.

17. The method according to claim 15, wherein the training data set of the data model includes at least one prediction domain marker.

18. The method according to claim 15, wherein the removal and/or hiding and/or modification of at least one training datum from the training data set depending on at least one domain parameter and/or domain value takes place successively and/or iteratively by varying the at least one domain parameter and/or domain value.

19. The method according to claim 18, wherein the training of a particular neural network, the determination of the model performance and the comparison of the determined model performance and the model performance associated with the training data set take place for each training data set reduced in this way successively and/or iteratively, to select a subset from the training data set, based on which subset the machine learning algorithm is trained.

20. The method according to claim 19, wherein the subset of the training data set includes training data which have no predetermined influence, depending on at least one threshold value, on the model performance.

21. The method according to claim 15, wherein an interaction between at least two of the domain parameters and/or domain values can be ascertained based on the comparison of the determined model performance with the model performance associated with the training data set.

22. The method according to claim 15, wherein the machine learning algorithm includes a neural network.

23. The method according to claim 15, wherein a production line including anequipment combination for producing specifiable products is furthermore provided.

24. The method according to claim 23, wherein after providing the production line, the method further comprises the step of: producing at least one specifiable product using the equipment combination.

25. A control unit included in an autonomous vehicle and/or a robotic system and/or an industrial machine, the control unit configured to execute a machine learning algorithm that has been trained by:
providing a domain model that has domain parameters and/or domain values for at least one domain;
providing a data model that has a training data set including training data for the at least one domain;
removing and/or hiding and/or modifying at least one training datum from the training data set depending on: (i) at least one domain parameter and/or (ii) at least one domain value, to provide a reduced training data set to evaluate a sensitivity of the at least one removed and/or hidden training datum;
trainining a neural network based on the reduced training data set to determine a model performance depending on the reduced data set;
comparing the determined model performance with a model performance associated with the training data set;
selecting training data from the training data set depending on the comparison of the model performances;
training the machine learning algorithm based on the selected training data; and
providing the trained machine learning algorithm.

26. A system configured for optimized training of a machine learning algorithm, the system comprising:
a provisioning device that is configured to provide a domain model that has domain parameters and/or domain values for at least one domain, and provide a data model that has a training data set including training data for the at least one domain; and
an evaluation and computing device configured to:
remove and/or hide and/or modify at least one training datum from the training data set depending on at least one domain parameter and/or domain value to provide a reduced training data set,
train a neural network on the basis of the reduced training data set in order to determine a model performance depending on the reduced data set,
compare the determined model performance with a model performance associated with the training data set;
select training data from the training data set depending on the comparison of the determined model performance and the model performance associated with the training data set. and
train the machine learning algorithm based on the selected training data;
wherein the provisioning device is furthermore configured to provide the trained machine learning algorithm.

27. A non-transitory computer-readable data carrier on which is stored program code of a computer program for optimized training of a machine learning algorithm, the program code, when executed by one or more computers, causing the one or more computers to perform the following steps:
providing a domain model that has domain parameters and/or domain values for at least one domain;
providing a data model that has a training data set including training data for the at least one domain;
removing and/or hiding and/or modifying at least one training datum from the training data set depending on: (i) at least one domain parameter and/or (ii) at least one domain value, to provide a reduced training data set to evaluate a sensitivity of the at least one removed and/or hidden training datum;
training a neural network based on the reduced training data set to determine a model performance depending on the reduced data set;
comparing the determined model performance with a model performance associated with the training data set;
selecting training data from the training data set depending on the comparison of the model performances;
training the machine learning algorithm based on the selected training data; and
providing the trained machine learning algorithm.
